(19) United States
(12) Patent Application Publication
(10) Pub. No.: US 2019/0231079 A1
(43) Pub. Date: Aug. 1, 2019

(54) VOICE ACTIVATED ADJUSTABLE BED SYSTEM

(71) Applicant: Fredman Brothers Furniture Company, Inc., St. Louis, MO (US)

(72) Inventor: John Schulte, Lake St. Louis, MO (US)

(21) Appl. No.: 15/880,710

(22) Filed: Jan. 26, 2018

(51) Int. Cl. A47C 17/86; G05B 19/042; A47C 21/00; G10L 15/22; A47C 17/04

(52) U.S. Cl. CPC A47C 17/86; G05B 19/042; A47C 21/003; G10L 2015/223; A47C 17/04; A47C 21/006; G05B 2219/23386; G10L 15/22

(57) ABSTRACT

A voice activated adjustable bed system is disclosed which has a voice activated module capable of receiving a voice command, converting the voice command into a signal, and transmitting the signal, an adjustable bed having a motor for adjusting a portion of the adjustable bed, and a module capable of receiving the transmitted signal and for operating the motor for adjusting the portion of the adjustable bed.

### BACKGROUND

This disclosure relates to adjustable beds and adjustable bed frames and more particularly to a voice activated adjustable bed system.

Conventional beds may consist of a mattress, a box spring, a headboard, a foot board, a pair of spaced apart bed rails, and longitudinally spaced, transversely extending wooden or metal slats extending between the bed rails. The slats and the bed rails are used to support the mattress and box spring above the floor upon which the bed is positioned. In order to provide for more comfort for an individual user of a bed, adjustable beds have been developed. Some adjustable beds are used for medical reasons such as aiding recovery for an individual. An adjustable bed may consist of one or more sections that may be moved or adjusted during use by employing actuators or motors to move the sections. Some known adjustable beds are operated by use of a wired control, a wireless remote control, or by use of a complicated speaker system that is part of the adjustable bed. Although such adjustable beds are available, due to their complexity and difficulty of use there is still a need for a better and user friendly system to operate adjustable beds through the use of voice control.

The present disclosure is designed to obviate and overcome many of the disadvantages and shortcomings associated with conventional adjustable beds. In particular, the present disclosure provides a voice activated adjustable bed system that is not complex and does not require sophisticated electronics associated with the adjustable bed. Moreover, the present disclosure is a voice activated adjustable bed system that allows voice commands to be recognized to operate the adjustable bed. The present voice activated adjustable bed system is applicable for use with full, queen, California kings, and king size adjustable beds.

### SUMMARY

In one form of the present disclosure, a voice activated adjustable bed system comprises a voice activated module capable of receiving a voice command, converting the voice command into a signal, and transmitting the signal, an adjustable bed having a motor for adjusting a portion of the adjustable bed, and a module capable of receiving the transmitted signal and for operating the motor for adjusting the portion of the adjustable bed.

In another form of the present disclosure, a voice activated adjustable bed system comprises an adjustable bed having a motor for adjusting a portion of the adjustable bed and a module connected to the motor, the module capable of receiving a signal from a voice activated device, and the module capable of operating the motor for adjusting the portion of the adjustable bed.

In yet another form of the present disclosure, a voice activated adjustable bed system comprises a voice activated module capable of receiving a number of different voice commands, converting each of the voice commands into a signal, and transmitting one or more of the signals, an adjustable bed having a number of motor for adjusting a different portion of the adjustable bed and a motor for actuating a device other than a motor, and a module capable of receiving one or more of the transmitted signals and for operating one of the motors for adjusting the portion of the adjustable bed associated with the motor and for operating the motor for actuating the device.

In light of the foregoing comments, it will be recognized that the present disclosure provides a voice activated adjustable bed system that may be actuated by a voice of an individual to operate various functions associated with an adjustable bed.

The present disclosure provides a voice activated adjustable bed system which can be easily employed and operated with highly reliable results.

The present disclosure is also directed to a voice activated adjustable bed system that responds to various voice commands to operate various functions associated with an adjustable bed.

The present disclosure also provides a voice activated adjustable bed system in which a voice activated device is separate from an adjustable bed so that the adjustable bed is compatible with various voice activated devices.

The present disclosure provides a voice activated adjustable bed system that is capable of being installed without the use of any specialized tools and can be easily operated without the use of any specialized equipment.

The present disclosure also provides a voice activated adjustable bed system that controls various devices associated with an adjustable bed.

The present disclosure provides a voice activated adjustable bed system that is employed to assist an individual to adjust and operate an adjustable bed through voice commands.

The present disclosure also provides voice activated adjustable bed system that can be operated with unlimited voice commands and unlimited adjustments of an adjustable bed through the use of the unlimited voice commands.

The present disclosure further provides a voice activated adjustable bed system that may be used with any sized mattress such as a full, twin, queen, California king, and king sized mattress.

The present disclosure is also directed to a voice activated adjustable bed system that comprises a module that may be constructed as part of an adjustable bed.

These and other applications and advantages of the present disclosure will become apparent after considering the following detailed specification in conjunction with the accompanying drawings, wherein

### BRIEF DESCRIPTION OF THE DRAWINGS

FIG. 1 is a block diagram of an embodiment of a voice activated adjustable bed system constructed according to the present disclosure;

FIG. 2 is a block diagram of an adjustable bed of the voice activated adjustable bed system constructed according to the present disclosure;

FIG. 3 is a schematic diagram of a module portion of the voice activated adjustable bed system constructed according to the present disclosure;

FIG. 4 is a block diagram of another embodiment of a voice activated bed system constructed according to the present disclosure; and

FIG. 5 is a schematic diagram of another embodiment of a module portion of the voice activated bed system shown in FIG. 4 and constructed according to the present disclosure.

### DETAILED DESCRIPTION OF EMBODIMENTS

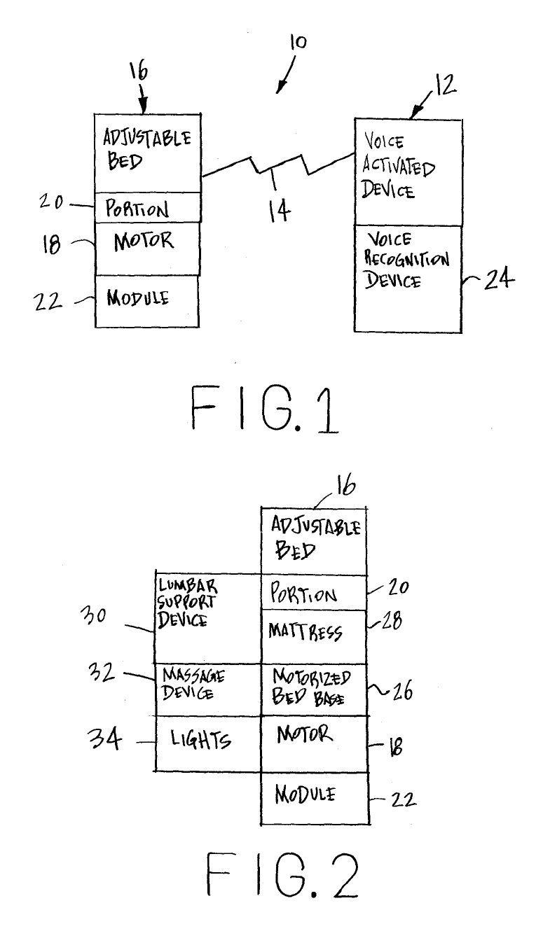

Referring now to the drawings, wherein like numbers refer to like items, number 10 identifies an embodiment of a voice activated adjustable bed system constructed according to the present disclosure. With reference now to FIG. 1, the voice activated adjustable bed system 10 is shown comprising a voice activated device or module 12 capable of receiving a voice command, converting the voice command into a signal, and transmitting the signal over a WiFi (wireless fidelity) channel 14 to an adjustable bed 16 having a motor 18 for adjusting a section or a portion 20 of the adjustable bed 16. For example, the adjustable bed 16 may be capable of adjusting a head section to elevate a head of an individual or a foot section for elevating feet of an individual. The adjustable bed 16 also has a module 22 capable of receiving the transmitted signal and for operating the motor 18 for adjusting the portion 20 of the adjustable bed 16. The voice activated module 12 may be a device that is connected to the Internet and has WiFi capabilities. The voice activated module 12 may also have a voice recognition device 24 for receiving voice commands or signals from an individual or user of the system 10. Examples of the voice activated module 12 may include an Amazon Echo device, an Amazon Echo Dot device, a Google Home device, and an Apple HomePod.

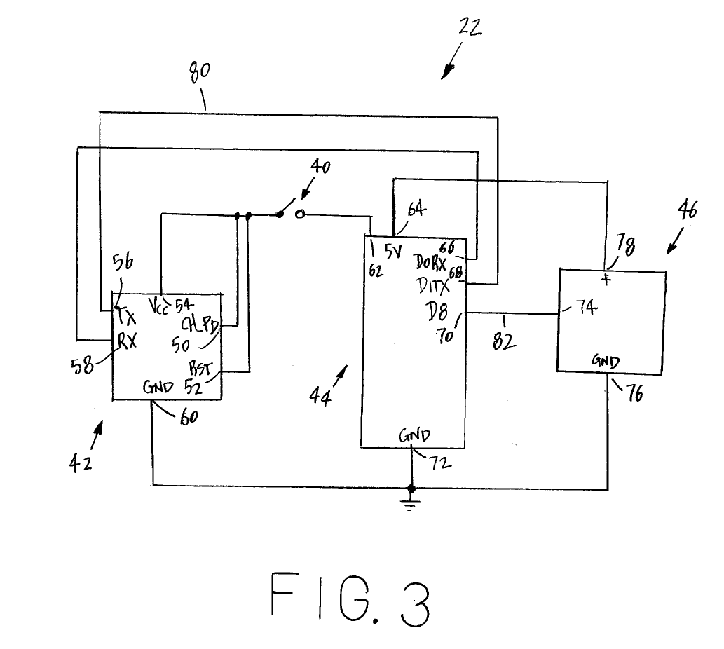

FIG. 2 illustrates a more detailed block diagram of the adjustable bed 16. The adjustable bed 16 has the motor 18 for adjusting the portion 20 of the adjustable bed 16. The adjustable bed 16 also has the module 22 capable of receiving the transmitted signal and for operating the motor 18 for adjusting the portion 20 of the adjustable bed 16. The adjustable bed 16 may also have a motorized bed base 26 upon which is placed a mattress 28, a lumbar support device 30, a massage device 32 for vibrating the mattress 28, and one or more lights 34 for illuminating various areas of the adjustable bed 16. The adjustable bed 16 allows for the mattress 32 to be put into different positions. For example, the adjustable bed 16 may be adjusted to prop up a head of an individual to view television or to read a book, or elevate legs of the individual for comfort, or sleep in a zero gravity position for further comfort. As can be appreciated, the adjustable bed 16 may have other features and components such as reading or night lights, a wave function device, a timer device, various movable and stationary frame members, solenoids, and linkages to connect the motor 18 to the various movable frame members. The adjustable bed 16 may be any size and shape such as conventionally available mattresses such as a full, queen, California king, or king sized mattress.

With reference now to FIG. 3, a schematic diagram of the module 22 is depicted. The module 22 has a switch 40, a WiFi module 42 connected to a microcontroller or microprocessor 44, and a motor control device 46. The WiFi module 40 is capable of receiving a signal over the channel 14. The switch 40 is used to operate the module 22. Although not shown, there are various other connections and devices that may be connected to the WiFi module 42 and the microcontroller 44. By way of example only, there may be various power connections to power the WiFi module 42 and the microcontroller 44. The WiFi module 42 is shown having an enable input (CH_PD) 50, a reset input (RST) 52, and a power input (Vcc) 54 connected to the switch 40. The WiFi module 42 also has a transmit data pin (TX) 56, a receive data pin (RX) 58, and a ground pin (GND) 60. The microcontroller 44 has a pin 62 connected to the switch 40. The microcontroller 44 also has a power output pin (5V) 64, a data receive pin (D0RX) 66, a data transmit pin (D1TX) 68, a data output (D8) 70, and a ground pin (GND) 72. The motor control device 46 has an input 74 connected to the data output (D8) 70 of the microcontroller 44, a ground pin (GND) 76, and a power input 78 which is connected to the power output pin (5V) 64 of the microcontroller 44. As can be appreciated, the WiFi module 42 and the microcontroller 44 may have various other components such as memory to store programs that operate the WiFi module 42 and the microcontroller 44. By way of example only, the WiFi module 42 may be a microcontroller or module such as the Adafruit HUZZAH ESP8266 and the microcontroller 44 may be a Raspberry Pi, an Intel or AMD microprocessor, or an Ardurino Uno.

The module 22 operates in the following manner. The switch 40 is closed to begin operation of the WiFi module 42 and the microcontroller 44. Any software incorporated into the WiFi module 42 and the microcontroller 44 is initialized and the module 22 is set for operation. The module 22 is then set into a state waiting to receive a signal over the channel 14 from the voice activated device 12. A signal transmitted over the channel 14 from the voice activated module 12 is received by the WiFi module 42. The WiFi module 42 then determines that a signal has been received and then transmits the signal from the transmit data pin (TX) 56 over a connection 80 to the data transmit pin (D1TX) 68 of the microcontroller 44. The microcontroller 44 then determines what needs to be done with the signal received from the WiFi module 42. For example, if the signal is interpreted to be operate the motor control device 46 then an appropriate signal will be sent out at the data output (D8) 70 over a connection or wire 80 to the input 74 of the motor control device 46 to operate the motor control device 46. For example, operation of the motor control device 46 may move the mattress associated with the adjustable bed 16. Again, by way of example only, the voice command that was spoken by an individual is to move the head portion of the mattress. In this example, a motor associated with moving or adjusting the head portion of the mattress would be operated.

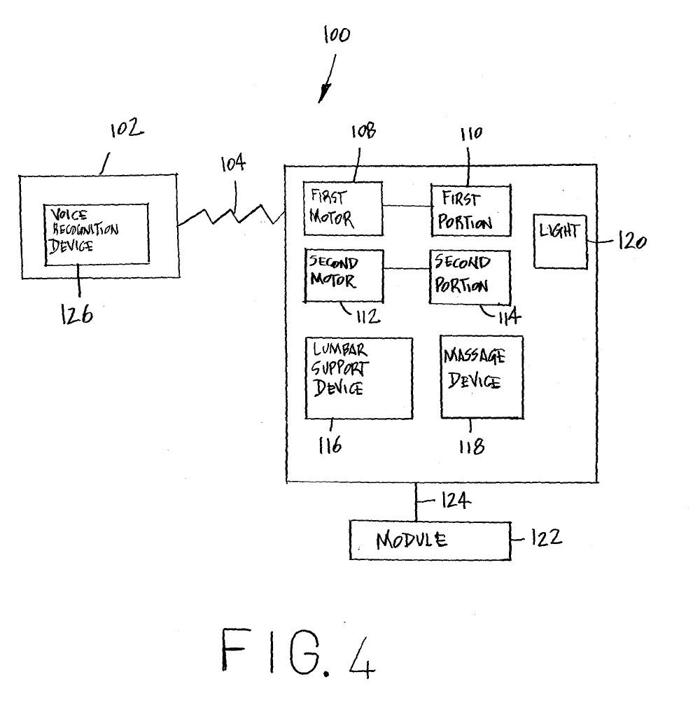

FIG. 4 depicts a block diagram of another embodiment of a voice activated adjustable bed system 100 constructed according to the present disclosure. The voice activated adjustable bed system 100 is shown to comprise a voice activated device or module 102 capable of receiving a voice command, converting the voice command into a signal, and transmitting the signal over a WiFi (wireless fidelity) channel 104 to an adjustable bed 106 having a first motor 108 for adjusting a first portion 110 of the adjustable bed 106, a second motor 112 for adjusting a second portion 114 of the adjustable bed 106, a lumbar support device 116 for providing lumbar support for the adjustable bed 106, a massage device 118 for providing a wave motion or a massage motion for the adjustable bed 106, and a light device 120 for illuminating the adjustable bed 106. The system 100 also has a module 122 capable of receiving the transmitted signal and for operating the first motor 108 for adjusting the first portion 110 of the adjustable bed 106, the second motor 112 for adjusting the second portion 114 of the adjustable bed 106, the lumbar support device 116, the massage device 118, and the light device 120. The module 122 may be connected to the adjustable bed 106 via wires 124 The voice activated module 102 may be a device that is connected to the Internet and has WiFi capabilities. The voice activated module 102 may also have a voice recognition device 126 for receiving voice commands or signals from an individual or user of the system 100. As indicated above, examples of the voice activated module 102 are an Amazon Echo device, an Amazon Echo Dot device, a Google Home device, an Apple HomePod, or similar functioning devices.

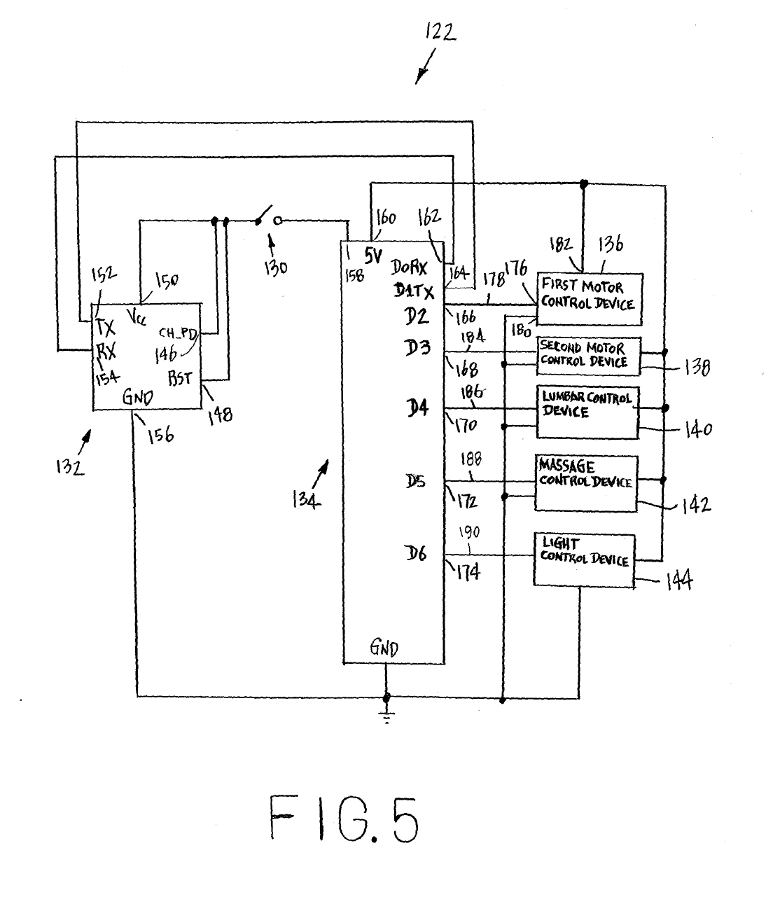

FIG. 5 shows a schematic diagram of the module 122 that may be used with the system 100. The module 122 comprises a switch 130, a WiFi module 132 connected to a microcontroller or microprocessor 134, a first motor control device 136, a second motor control device 138, a lumbar support control device 140, a massage control device 142, and a light control device 144. The WiFi module 132 is capable of receiving a signal over the channel 104 (FIG. 4). The switch 130 is used to operate the module 122. Although not shown, there are various other connections and devices that may be connected to the WiFi module 132 and the microcontroller 134. By way of example only, there may be various power connections to power the WiFi module 132 and the microcontroller 134. The WiFi module 132 is shown having an enable input (CH_PD) 146, a reset input (RST) 148, and a power input (Vcc) 150 connected to the switch 130. The WiFi module 132 also has a transmit data pin (TX) 152, a receive data pin (RX) 154, and a ground pin (GND) 156. The microcontroller 134 has a pin 158 connected to the switch 130. The microcontroller 134 also has a power output pin (5V) 160, a data receive pin (D0RX) 162, a data transmit pin (D1TX) 164, and data outputs (D2) 166, (D3) 168, (D4) 170, (D5) 172, and (D6) 174. The first motor control device 136 has an input 176 connected to the data output (D2) 166 of the microcontroller 134 via a wire 178, a ground pin (GND) 180, and a power input 182 which is connected to the power output pin (5V) 160 of the microcontroller 134. The second motor control device 138 is connected to the data output (D3) 168 by a wire 184, the lumbar support control device 140 is connected to the data output (D4) 170 by a wire 186, the massage control device 142 is connected to the data output (D5) 172 by a wire 188, and the light control device 144 is connected to the data output (D6) 174 by a wire 190. For example, a signal sent from the data output (D3) 166 over the wire 180 will operate the second motor control device 138. The other devices 140, 142, and 144 are operated in a similar manner by sending a signal over the data outputs 170, 172, and 174, respectively. As can be appreciated, the WiFi module 132 and the microcontroller 134 may have various other components such as memory to store programs that operate the WiFi module 132 and the microcontroller 134. Again, by way of example only, the WiFi module 132 may be a microcontroller or module such as the Adafruit HUZZAH ESP8266 and the microcontroller 134 may be a Raspberry Pi, an Intel or AMD microprocessor, or an Ardurino Uno.

The module 122 operates in the following manner. The switch 130 is closed to initiate operation of the WiFi module 132 and the microcontroller 134. Any software incorporated into the WiFi module 132 and the microcontroller 134 is initialized and the module 122 is set for operation. The module 122 is then set into a state waiting to receive a signal over the channel 104 from the voice activated device 102. A signal transmitted over the channel 104 from the voice activated module 102 is received by the WiFi module 132. The WiFi module 132 then determines that a signal has been received and then transmits the signal from the transmit data pin (TX) 152 over a connection 192 to the data transmit pin (D1TX) 164 of the microcontroller 134. The microcontroller 134 then determines what needs to be done with the signal received from the WiFi module 132. For example, if the signal is interpreted to be operate the second motor control device 138 then an appropriate signal will be sent out at the data output (D3) 168 over the wire 180 to control operation of the second motor control device 138 to operate the second motor 112 (FIG. 4). For example, operation of the second motor control device 138 may move a foot portion of the adjustable bed 106 upwardly and which moves the mattress associated with the adjustable bed 106 upwardly. Again, by way of example only, the voice command that was spoken by an individual is to move the foot portion of the mattress. In this example, the second motor 112 associated with moving or adjusting the foot portion of the mattress would be operated and the foot portion of the mattress would be adjusted accordingly. By way of another example, a voice command to turn on the light 120 (FIG. 4) would have the microcontroller 134 send a signal from the data output (D6) 174 over the wire 190 to operate the light control device 144 which would turn on the light 120.

Some of the voice commands that may be received by the voice recognition devices 24 and 126 to operate various functions or actions associated with the adjustable beds 16 and 106, respectively, may include: STOP, to stop the last voice command action; HEAD UP, to move or adjust or lift the head section of the adjustable bed up until the STOP command is provided or received; HEAD DOWN, to move or adjust or drop the head section of the adjustable bed down until the STOP command is provided; FOOT UP, to move or adjust or lift the foot section of the adjustable bed up until the STOP command is provided; FOOT DOWN, to move or adjust or drop the foot section of the adjustable bed down until the STOP command is provided; ELEVATE, to begin to lift the adjustable bed until the STOP command is provided; DESCEND, to begin to drop or lower the adjustable bed until the STOP command is provided; NECK UP, to begin to move or adjust or lift the neck section of the adjustable bed until the STOP command is provided; NECK DOWN, to begin to move or adjust or lower the neck section of the adjustable bed until the STOP command is provided; LUMBAR UP, to begin to increase air provided to the lumbar support device of the adjustable bed until the STOP command is provided; LUMBAR DOWN, to begin expel air in the lumbar support device of the adjustable bed until the STOP command is provided; ZERO GRAVITY, to begin to move the head and foot sections of the adjustable bed into a Zero Gravity position until the STOP command is provided; GO FLAT, to move the adjustable bed into a flat position until the STOP command is provided; ANTI SNORE, to begin to move the head section of the adjustable bed into an anti snore position until the STOP command is provided; BED LIGHT ON, turns on the bed light; BED LIGHT OFF, turns off the bed light; MEMORY A, moves the adjustable bed into memory A position until the STOP command is provided; MEMORY B, moves the adjustable bed into memory B position until the STOP command is provided; SLEEP WAVE 1, turns on the massage device such as a vibration device on pulse mode at the lowest setting or level; SLEEP WAVE 2, turns on the massage device such as a vibration device on pulse mode at a middle setting or level; SLEEP WAVE 3, turns on the massage device such as a vibration device on pulse mode at the highest setting or level; SLEEP INTENSITY 1, turns on the massage device such as a vibration device at a frequency at the lowest setting or level; SLEEP INTENSITY 2, turns on the massage device such as a vibration device at a frequency at the middle setting or level; SLEEP INTENSITY 3, turns on the massage device such as a vibration device at a frequency at the highest setting or level; SLEEP TIME 10, turns on the massage device for a period of ten minutes; SLEEP TIME 20, turns on the massage device for a period of twenty minutes; SLEEP TIME 30, turns on the massage device for a period of thirty minutes; SLEEP OFF, turns off the massage device; SET MEMORY (A or B or C), begins a sequence to save a specific setting; MEMORY (A or B or C) HEAD UP, head section of the adjustable bed begins to move up until the STOP command is provided; MEMORY (A or B or C) FOOT UP, foot section of the adjustable bed begins to move up until the STOP command is provided; MEMORY (A or B or C) ELEVATE, the adjustable bed begins to lift up until the STOP command is provided; MEMORY (A or B or C) NECK UP, neck section of the adjustable bed begins to move up until the STOP command is provided; MEMORY (A or B or C) LUMBAR UP, lumbar section of the adjustable bed begins to fill with air until the STOP command is provided; and SAVE MEMORY (A or B or C), saves settings just selected. As can be appreciated, more settings are capable of being employed through the use of voice activation commands. It is also possible and contemplated that other voice commands may be recognized or programmed to operate the adjustable beds 16 and 106 with such voice commands being unlimited and operations of the adjustable beds 16 and 106 also being unlimited.

The systems 10 and 100 may operate by use of one or more of the above identified voice commands. In particular, when using the system 100, an individual wanting to adjust the lumbar support device 116 associated with the adjustable bed 106 would announce the command “LUMBAR UP” and the voice recognition device 126 of the voice activated module 102 would translate the voice command into a signal by use of circuitry and software incorporated within the voice activated module 102. As is known, the voice activated module 102 may also be connected to the Internet and some of the processing of voice commands may take place outside of the module 102. The signal is then transmitted over the channel 104 to be received by the module 122. The WiFi module 132 then sends the signal over the connection 192 to the data transmit pin (D1TX) 164 of the microcontroller 134. The microcontroller 134 will then send a signal out at the data output (D4) pin 170 to the lumbar control device 140 to operate or inflate the lumbar support device 116. This will continue until the lumbar support device 116 inflates to its highest setting or until a “STOP” command is spoken. As can be appreciated, when the “STOP” command is received by the voice activated module 102 a signal is transmitted by the module over the channel 104 to the module 122. The WiFi module 132 will then send the signal over the connection 192 to the data transmit pin (D1TX) 164 of the microcontroller 134. The microcontroller 134 will then turn off the data output (D4) pin 170 to stop the signal being provided to the lumbar control device 140. At this point the lumbar support device 116 stops inflating.

From all that has been said, it will be clear that there has thus been shown and described herein a voice activated adjustable bed system which fulfills the various advantages sought therefore. It will become apparent to those skilled in the art, however, that many changes, modifications, variations, and other uses and applications of the subject voice activated adjustable bed system are possible and contemplated. All changes, modifications, variations, and other uses and applications which do not depart from the spirit and scope of the disclosure are deemed to be covered by the disclosure, which is limited only by the claims which follow.

What is claimed is:

1. A voice activated adjustable bed system comprising:
a voice activated module capable of receiving a voice command, converting the voice command into a signal, and transmitting the signal;
an adjustable bed having a motor for adjusting a portion of the adjustable bed; and
a module capable of receiving the transmitted signal and for operating the motor for adjusting the portion of the adjustable bed.

2. The voice activated adjustable bed system of claim 1 wherein the module comprises a WiFi module and a microcontroller.

3. The voice activated adjustable bed system of claim 1 wherein the module comprises a WiFi module and a microprocessor.

4. The voice activated adjustable bed system of claim 1 wherein the module comprises a WiFi module.

5. The voice activated adjustable bed system of claim 1 wherein the module is attached to the adjustable bed.

6. The voice activated adjustable bed system of claim 1 wherein the module is connected to the motor.

7. The voice activated bed system of claim 1 wherein the voice activated module is further capable of receiving a second voice command, converting the second voice command into a second signal, and for transmitting the second signal.

8. The voice activated bed system of claim 1 wherein the adjustable bed further comprises a mattress and the motor is capable of moving the mattress.

9. A voice activated adjustable bed system comprising:
an adjustable bed having a motor for adjusting a portion of the adjustable bed; and
a module connected to the motor, the module capable of receiving a signal from a voice activated device, and the module capable of operating the motor for adjusting the portion of the adjustable bed.

10. The voice activated adjustable bed system of claim 9 wherein the module further comprises a WiFi module and a microcontroller.

11. The voice activated adjustable bed system of claim 9 wherein the module further comprises a WiFi module and a microprocessor.

12. The voice activated adjustable bed system of claim 9 wherein the module further comprises a WiFi module.

13. The voice activated adjustable bed system of claim 9 wherein the module is attached to the adjustable bed.

14. The voice activated adjustable bed system of claim 9 wherein the module is connected to the motor by a wire connection.

15. The voice activated adjustable bed system of claim 9 wherein the module comprises a microcontroller.

16. A voice activated adjustable bed system comprising:
a voice activated module capable of receiving a number of different voice commands, converting each of the voice commands into a signal, and transmitting one or more of the signals;
an adjustable bed having a number of motor for adjusting a different portion of the adjustable bed and a motor for actuating a device other than a motor; and
a module capable of receiving one or more of the transmitted signals and for operating one of the motors for adjusting the portion of the adjustable bed associated with the motor and for operating the motor for actuating the device.

17. The voice activated adjustable bed system of claim 16 wherein the device other than a motor is a light.

18. The voice activated adjustable bed system of claim 16 wherein the device other than a motor is a lumbar support device.

19. The voice activated adjustable bed system of claim 16 wherein the device other than a motor is a massage device.

20. The voice activated adjustable bed system of claim 16 wherein the module further comprises a WiFi module.
